(19) United States
(12) Patent Application Publication
(10) Pub. No.: US 2005/0149624 A1
(43) Pub. Date: Jul. 7, 2005

(54) Modular communication server

(76) Inventors: Daniel Jakubiec, Atlanta, GA (US); Donald G. Armerding, San Diego, CA (US); Jay A. Foster, San Diego, CA (US); Randall C. Schulz, Spring Valley, CA (US); Don M. Lyle, La Jolla, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 10/993,226

(22) Filed: Nov. 19, 2004

Related U.S. Application Data
(60) Provisional application No. 60/524,307, filed on Nov. 21, 2003.

(51) Int. Cl. G06F 15/16

(52) U.S. Cl. 709/217; 710/305

(57) ABSTRACT

A modular communication server provides a single communication interface between a host and a number of communication devices. The modular communication server can be configured to support multiple communication devices using one or more communication protocols. The modular communication server includes a master communication controller that provides the interface between the network and devices using a first communication protocol. Slave communication controllers can be connected to a bus internal to the modular communication server. Each of the slave communication controllers can independently support devices using a communication protocol. The master communication controller controls the communication between the host and each slave communication controller.

### RELATED APPLICATIONS

This application claims the benefit of U.S. Provisional Application No. 60/524,307, filed Nov. 11, 2003, which is hereby incorporated by reference.

### BACKGROUND OF THE INVENTION

1. Field of the Invention

The invention relates to the field of electronic communications. More particularly, the invention relates to networked data communications.

2. Description of the Related Art

Over the last two decades, the population and types of equipment that connect to a computer (a Peripheral) has grown exponentially. As the range of equipment has expanded, so too has the volume of data that is exchanged between any single Peripheral and a computer. To meet this need, technology that is applied within the equipment that serves as a conduit between a computer and other computers and/or Peripherals (Data Communication Equipment) has evolved, driven also by the need to communicate at faster rates and for less cost.

Historically, Data Communication Equipment that services a local computer and a local Peripheral have conformed to a set of standards for “serial communication”. The rapid growth of the types and number of Peripherals attached to computers has helped to highlight limitations in the older “serial communication” standards, including distance limitations, inadequate connectors and inefficient physical interfaces.

Data Communication Equipment built to the original “serial standard” inherently places limits on the distance between any Peripheral and a computer. Peripherals are no longer limited to the immediate vicinity of the computer, but instead may be located in a different part of a building, in a different building, or even in a different city, these distance limitations create unacceptable constraints. These distance limitations have generally been overcome by providing a “bridge” between the serial-based Peripheral and the computer over a network.

Many times, the “standard serial” connector used in Data Communication Equipment has failed to provide a reliable connection and/or a proper “fit” within the environment of some of the newer applications. In response, various connectors have been developed that provide a more effective and/or efficient physical interface, or “fit” into the different operating environments. To provide enhanced efficiency or effectiveness, electrical interfaces have evolved that accommodate multiple Peripherals through a single physical interface. Various software protocols have been developed to bridge the physical equipment with different operating systems. In addition, individual customers of Data Communication Equipment often require similar solutions but at far varying levels of scale.

As the number of connectors interfaces and protocols have expanded, Providers have been forced to significantly expand the breadth of their product offerings. Due to the diverse customer environments, the communication equipment provider has developed a large number of product models, each tailored with a unique combination of physical interfaces, connectors, protocols, and scale to meet the wide range of applications. To minimize costly and time-consuming development, many equipment providers have elected to limit product development. Instead of developing products that optimally fit all customers' needs, they have chosen instead to group those combinations of interfaces, connectors, protocols and scale, which are most frequently selected into “packaged solutions”. As a result, many customers are forced to choose between products that have imperfect application fit or to select a more costly product that provides a superset of features needed.

Although these “packaged solutions” have allowed a Provider to reduce the number of development projects, the number of product configurations remain very high and growing. Providers have frequently found development costs rising disproportionately to the opportunity. Moreover, the designs are growing increasingly complex as new interfaces, connectors and protocols are introduced in response to new segments and growing market needs.

In addition to the “development” problem, the Provider's manufacturing organization has been burdened as they attempt to carry the optimal inventory for an ever-expanding population of product models. By necessity, the Provider must attempt to limit cash outlays for inactive inventory. The Provider frequently builds a mix of models that is based upon a periodic forecast that projects the need for each particular model over a future period. Forecasts are imprecise. An inability to optimally project the demand leads inevitably to excess inventory of some models and insufficient inventory in others.

The cost of surplus inventory or missed opportunity is extremely disadvantageous to the Provider. All too often large sums of cash are consumed in stagnant inventory whose dispersion must await a customer's order prior to realizing any redemptive value. Thus, holding inventory for a sustained period can create significant cash flow problems for the Provider.

Insufficient inventory can mean missed opportunity since the customer's need for a specific configuration frequently cannot be deferred until the Provider is able to restock that model.

The disadvantages of current products include high inventory costs; lack of sufficient scalability of the product; long, costly and frequent product development projects; lack of flexibility of the product; unsatisfied customers; and lack of availability.

### SUMMARY OF THE INVENTION

Various aspects of the invention relate to a modular communication server which allows communication between a host and one or more remote communication devices. A host can communicate to all of the remote communication devices by communicating with a single communication port on the communication server. The modular communication server can be configured to support one or more physical interfaces supporting one or more communication protocols.

In one aspect of the invention, a master communication controller within the communication server can be configured to control the communication interface with the host. The master communication controller can also support one or more communication ports corresponding to one or more communication protocols. Additionally, the master communication controller controls a bus internal to the communication server.

One or more slave communication controllers can be optionally coupled to the internal bus. Each slave communication controller can also support one or more communication ports corresponding to one or more communication protocols. Each slave communication controller can be configured on a removable module. Different slave communication controllers can be preconfigured to support different communication protocols. In this manner, the communication server can be configured to support a variety of physical interfaces and protocols by adding or omitting slave communication controllers. The final configuration of the communication server can be determined at the time of final manufacture.

In a further aspect of the invention, a modular communication server includes a master communication port controller having a network interface module configured to communicate over a network, and a bus interface module configured to communicate over an internal bus;. An internal bus is coupled to the bus interface. A slave communication port controller has a peripheral controller coupled to the internal bus and a port interface module in communication with the peripheral controller and configured to provide a port interface to an external device.

In a further aspect, the master communication port controller further includes a communication controller module configured to receive data from the network interface module and determines its destination within the master communication port controller. Additionally, the master communication port controller further includes a local application module configured to control the operation one or more external devices coupled to the slave communication module and which are not directly usable or accessible by a host computer.

In another aspect, the slave communication port controller includes a plurality of port interface modules, each configured to provide a port interface to an external device. Additionally, the system can include a remote device server configured to receive data from a host via the network interface module and convert the data to a format suitable for an external device coupled to the port interface module.

Additionally, the master port controller further includes a port interface for an external device.

In another aspect, a modular communication server includes a plurality of port interface modules, each configured to provide a port interface, a plurality of peripheral controllers, each coupled to one of the plurality of port interface modules and configured to provide communication via an internal bus, an internal bus coupled to each of the plurality of peripheral controllers, a bus interface coupled to the internal bus, a communication controller module in communication with the bus interface module and configured to direct data to selected ones of the plurality of port interface modules via the internal bus, and a network interface module coupled to the communication controller module and configured to provide communication over a network.

Another aspect includes a method of operating a modular communication server having plurality of external devices. The method includes receiving data from a host computer intended for a local/remote device; converting the data received from the host computer to a format compatible with an internal bus; transmitting the converted data over an internal bus to a slave communication port controller; and converting the data received at the slave communication port controller to a format compatible with the local/remote device coupled to the slave communication port controller.

Additionally the method can include directing to more than one local/remote device and directing data to an external device on the internal bus.

### BRIEF DESCRIPTION OF THE DRAWINGS

The above-described aspects and other aspects, features and advantages of the invention will be apparent upon review of the following detailed description and the accompanying drawings. In the drawings like reference characters identify identical or functionally equivalent elements.

FIG. 1 is a functional block diagram of a networked communication system.

FIG. 2 is a functional block diagram of a networked communication system including a communication server.

FIG. 3 is a functional block diagram of a communication server.

FIG. 4 is a functional block diagram of a communication port controller.

FIG. 5 is an exploded view of a modular communication server.

FIG. 6 is a flowchart of a manufacturing process for a modular communication server.

### DETAILED DESCRIPTION OF EMBODIMENTS OF THE INVENTION

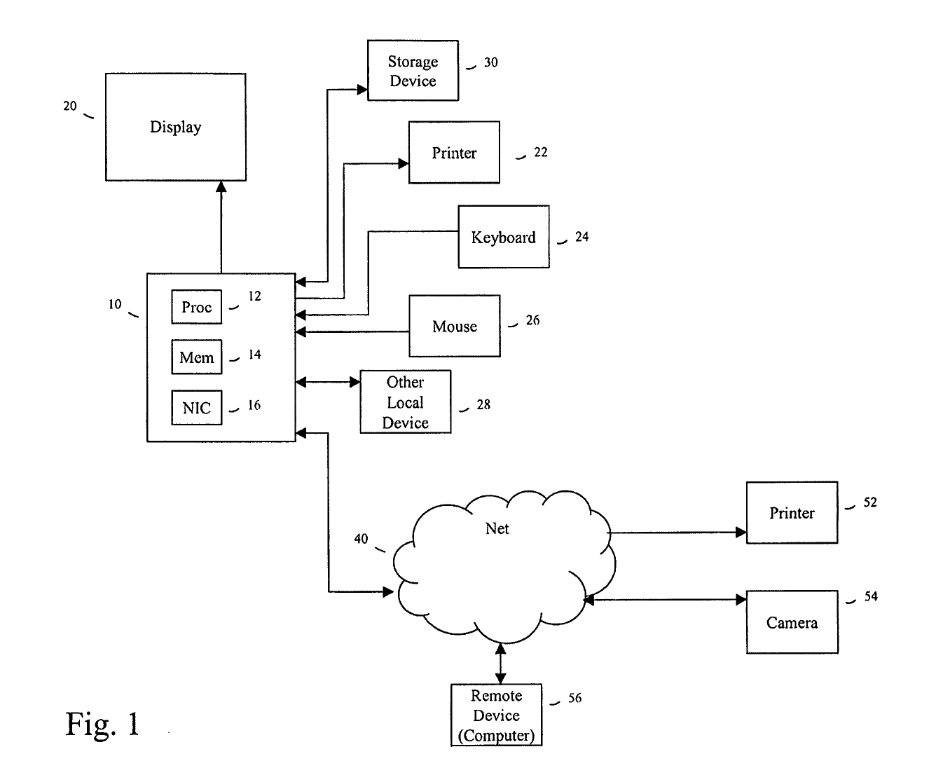

FIG. 1 is a block diagram of a remote communication system with a host in communication with various local and remote devices. A host 10, here shown as a computer, can include a processor 12 and memory 14. The host 10 can be in communication with one or more local devices. The local devices can use similar communication protocols or can each communicate to the host 10 using a different communication protocol.

For example, the host 10 can be in communication with a display 20, a printer 22, a keyboard 24 or other input device, a mouse 26, and some other type of local device 28. Additionally, the host 10 may be in communication with a storage device 30, such as an external disk drive.

The host 10 can be coupled to the local devices through a wired or wireless communication link. The communication between the host 10 and any of the local devices can be unidirectional or bidirectional. Additionally, the local devices can use similar or different communication protocols and physical interfaces. For example, the printer 22 can use a parallel printer port having an associated physical interface and communication protocol. The mouse 26 and keyboard 24 can both use serial communication protocols but may interface using different physical interfaces.

Still other local devices, here shown as a camera 28, can use serial communication protocols that have different physical interfaces and protocols than those used by other devices. The Universal Serial Bus (USB) is an example of a serial bus which brings a level of intelligence to serial devices. The new bus is faster than previously available serial busses and can handle greater amounts of data and supports a discovery process that allows devices to be identified as they are connected or removed from the bus. USB allows the system user a level of self configuration.

The host 10 can also be connected to a network 40, such as a Local Area Network (LAN) or Wide Area Network (WAN) in order to communicate with remote devices. The host 10 can, for example, interface with the network 40 using a network interface module 16 which can be a network interface cord (NIC). Alternatively, the network 40 can be a serial network, an SCSI network or a Firewire network.

Remote devices can also be connected to the network 40. For example, a printer 52, camera 54 or other computer 56 can be connected to the network 40. The host 10 can then communicate with the remote devices via the network 40. One disadvantage with the system shown in FIG. 1 is that each of the remote devices requires the capability to connect to the network 40. Often, a device is unable to communicate with the host 10 using the communication protocols of the network 40.

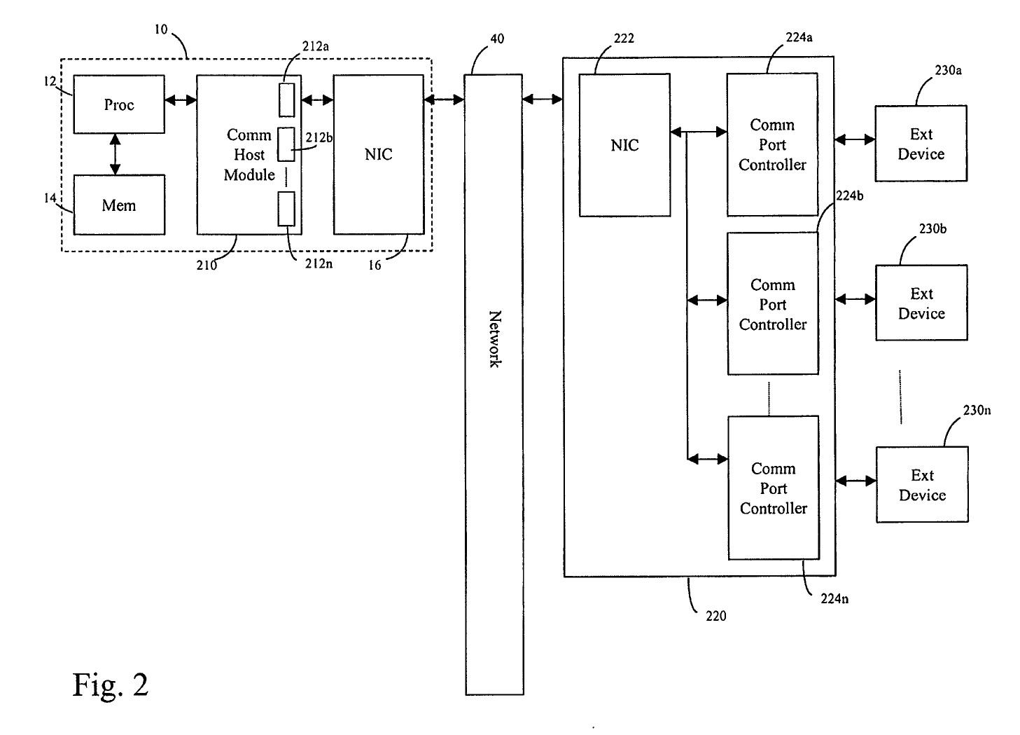

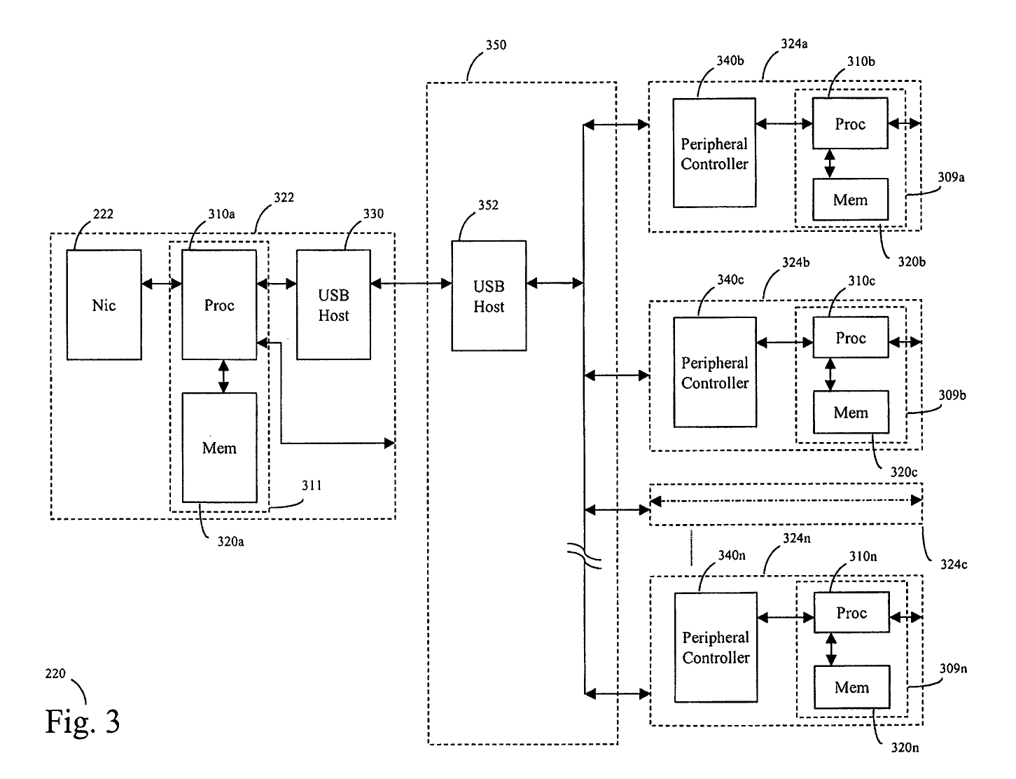

FIG. 2 is a functional block diagram of a host 10 communicating over a network 40 to a communication server 220 that is in communication with multiple remote devices 230a-230n. FIG. 3, discussed below, provides a more detailed functional block diagram of an embodiment of the communication server 220.

The various elements of the system shown in FIG. 2 can be configured such that one or more of the remote devices 230a-230n appear to software applications running on the host 10 as if they were locally connected to the host 10. Devices which are remote from the host but appear to the host as local devices can be referred to as local/remote devices. The host 10 can individually access each of the local/remote devices via the communication server 220. The host 10 can thus read data from each individual local/remote device. Similarly, the host 10 can send commands or instructions or write data to local/remote devices, in a manner that appears to a software application on the host, as if they were directly connected to the host 10. The host 10 can multiplex the various commands, instructions, and data to be sent to the local/remote devices into a single communication protocol used to communicate the information over the network 40. The communication server 220 receives the multiplexed information from the network 40 and demultiplexes the commands, instructions, and data. The communication server 220 then routes particular commands, instructions, and data to the appropriate remote device.

The host 10 can include a processor 12, which can be coupled to a memory 14. A communication host module 210 is also located within the host 10. Though the communication module 210 is depicted in FIG. 2 as separate from the processor 12 and the memory 14, it can be configured as a software program which is stored in the memory 14 and executed by the host processor 12. Alternatively, the communication host module 210 can be separate from and in communication with the processor 12.

The communication host module 210 is configured to act as an interface between software applications running on the processor 12 and the communication server 220 such that the remote devices 230a-n appear to be local devices to those software applications. In one embodiment, the communication host module 210 includes one or more communication interface modules 212a-212n. Each communication interface module provides an application programming interface (API) for different communication protocols which may be utilized by the different remote devices 230a-230n. For example, a first communication interface module 212a can provide an API for RS-232 serial port applications. The second communication interface module 212n can provide an API for USB applications. Therefore, when a software application is executed on the host processor 10, which is to interface with remote device 230a, it will utilize module 212a with its API for RS-232 serial port applications, assuming that device 230a utilizes an RS-232 protocol. The communication interface modules 212a-212n can be implemented in hardware, firmware, or software or a combination of those. Additionally, the functions associated with one or more of the communication interface modules can be combined into a single module.

The communication host module 210 is coupled to the network module 16 that interfaces the host 10 to the network 40. The network module 16 can be, for example, a network interface card that interfaces a personal computer to an Ethernet communication network. The network 40 can be any type of communication network including, but not limited to, a LAN, a WAN, a wireless network, the Internet, or some other communication network.

The communication server 220 is also coupled to the network 40. Typically, the communication server 220 connects to the network 40 at a location that is remote from the host 10, although such a remote connection is not a requirement. The communication server 220 receives communication from the host 10 over the network, via the network module 16 and the communication host module 210, determines the appropriate remote device, and routes the communication to that device. Additionally, communication from the host 10 can be a bundle of communications to different network devices in which case they are first de-multiplexed. Similarly, the communication server 220 can receive information from each of the remote devices 230a-230n and convert that information to a communication protocol used for communicating to the host 10 via the network 40. Information from more than one remote device can also be multiplexed for transmission over the network 40.

The communication server 220 includes a network module 222 to enable it to communicate over the network 40. The network module 222 can be the same as or similar to the network module 16. The communication server 220 also includes one or more communication port controllers 224a-224n that can each be connected to one or more remote communication devices 230a-230n.

Each communication port controller 224a-224n can be configured to convert the data received from the remote device, for example 230a, from the protocol used by the remote device to a communication protocol that is compatible with the network module 222. Each communication port controller 224a-224n can be configured to provide a particular type of communication port. For example, a first communication port controller 224a can be configured to provide multiple RS-232 serial ports. Similarly, the other communication port controllers 224b-224n can be configured to provide other types of communication ports. For example, a communication port controller 224b can be configured to support RS-232, RS-422, RS-485, USB, IEEE-488, IEEE-802, parallel port, wireless, SCSI, firewire, standard telephone, modem, proprietary protocol, or some other communication protocol. Each communication protocol can have a corresponding physical interface, although some communication protocols may share the same type of physical interface.

The communication server 220 thus allows the host 10 to communicate with the remote devices 230a-230n via the network 40. The communication host module 210 allows the host 10 to communicate, using the communication server 220, with the remote devices 230a-230n as if they were local to the host 10. The number of remote devices 230a-230n can be the same as or different from the number of communication port controllers 224a-224n. Some communication port controllers can support more than one communication port and thus more than one remote device. Additionally, more than one remote device can be supported through a single port. Other communication port controllers can support only a single physical interface and communication protocol.

As described below in further detail, the network module 222 and a first communication port controller 224a can be configured as a master communication port controller. The master communication port controller can have one or more ports itself. The other communication port controllers 224b-224n can be configured as modules that can be removably connected to an internal bus within the communication server 220.

In an example of the system of FIG. 2, a host 10 can connect to the Internet 40 using an Ethernet connection provided by a network interface card 16. A communication server 220 can be connected to the Internet 40 at a location that is remote from the host 10. Two remote devices 230a, 230b, can be connected to the communication server 220. A first remote device 230a can be an RS-232 serial port device. A second remote device 230b can be a USB device.

The communication server 220 can send a notification to the host 10 after each of the remote devices 230a-230b is connected to communication port controllers 224a-224b in the communication server 220. The notification can include, for example, any identifiers such as a location or address used internally by the communication server 220 to identify each remote device 230a-230b. The communication server 220 can also notify the host 10 of the type of communication protocol used by the remote device 230a-230b, here RS-232 and USB.

The notifications sent by the communication server 220 to the host 10 are received at the network interface card 16 and communicated to the communication host module 210. The communication host module 210 evaluates the notification and provides the information to the appropriate communication interface modules 212a-212b.

A first communication interface module 212a can be configured to provide an API for serial port devices. A second communication interface module 212b can be configured to provide an API for USB devices. Thus, the first communication interface module 212a presents an interface to the first remote device 230a that makes it appear to applications running in the host 10 that the first remote device 230a is connected locally to the host 10. Similarly, the second communication interface module 212b presents an interface to the second remote device 230b that makes it appear to applications running in the host 10 that the second remote device 230b is connected locally to the host 10.

An application running on the processor 12 in the host 10 can send a command to the first remote device 230a as if the device were local to the host 10. The processor 12 communicates the command to the API of the first communication interface module 212a in the communication host module 210. The first communication interface module 212a appears to the application as the remote device and forwards the command as Ethernet communication protocol data. The Ethernet protocol data is then provided to the network interface card 16 that connects the host 10 to the Internet 40.

The communication server 220 receives the Ethernet data at a network interface module 222. In one embodiment, each communication port controller examines the Ethernet data and extracts data addressed to the associated remote device. The first communication port controller 224a thus retrieves the command for the first remote device 230a and communicates the command to the device. Alternatively, as depicted in FIG. 3, a master port controller performs that function.

FIG. 3 is a functional block diagram of an embodiment of a modular communication server 220, such as the one shown in the system of FIG. 2. The modular communication server 220 includes a master communication port controller 322 in communication with one or more slave communication port controllers 324a-324n via an internal bus 350. In the embodiment of FIG. 3, the internal bus is a serial bus such as USB. (other buses can be used.). In one embodiment the slave communication port controllers are independent computers (they include a central processing unit, a memory and its own internal bus). The internal bus 350 allows the communication server 220 to appear to function as a single device. Devices external to the modular communication server are insulated from the internal complexity of the modular communication server by the master communication port controller. When each of the slave communication port controllers is an independent computer, the complexity of the master communication port controller can be minimized because of the capabilities of the slave communication port controllers. Further, this allows a master communication port controller to be used with many slave communication port controllers while only requiring a single bus connection.

The master communication port controller 322 includes a network module 222 and a controller 311. In one embodiment, the controller 311 includes a processor 310a with associated memory 320a. The master port controller 322 can provide none, one or more communication ports supporting one or more communication protocols. For example, the processor 310a and memory 320a in the master communication port controller 322 can be configured to support two RS-232 serial ports.

The master communication port controller 322 also is configured to control communications over a bus that is internal to the communication server 220. The master communication port controller 322 includes a bus interface module 330. In this embodiment, the internal bus is USB and the bus interface module 330 is a USB host module which is coupled to the processor 310a. The USB host module can include, for example, USB host controller integrated circuits manufactured by Intel, Philips, or Cypress. In other embodiments, a different internal bus protocol may be implemented. The host controller would correspond to the communication protocol used in the internal bus.

In one embodiment, no additional modules are required when the communication server 220 is configured to support only the communication ports supported by the master communication port controller 322. However, additional modules can be added to the communication server 220 if the communication server 220 is configured to support additional communication ports.

USB allows for the expansion of the number of devices connected to the bus using a USB hub. It is convenient to include a USB backplane 350 having a USB hub module 352. The USB hub module 350 can include, for example, USB hub integrated circuits manufactured by Intel, Philips, or Cypress. The USB hub module 352 on the backplane 350 couples to the USB host module 330 on the master communication port controller 322. The backplane 350 allows for a number of USB modules to be coupled to the backplane and communicate with the master communication port controller 322.

The communication server 220 is then easily expanded to support additional communication ports of essentially any number, communication protocol, or physical interface. In order to support a particular communication protocol and physical interface, a slave communication port controller 324a-324n supporting that communication port is connected to the backplane 350. Additionally, a slave communication port controller can have no port and instead (or in addition to a port) provide a peripheral function such as flash memory or other type of memory within the slave communication port controller. That can be contrasted with attaching a memory device to a port provided by a slave communication port controller.

The USB protocol specifies the types of connections used by the host and peripheral devices. The connections on the backplane 350 that interface with connections on the slave port controllers 324a-324n can be configured in accordance with the USB specifications. Alternatively, some other connection may be used, including a proprietary connection. It can be advantageous to include removable couplings or connectors on the backplane 350 and communication port controllers 324a-324n to allow easy configuration of the communication server 220.

The slave communication port controllers 324a-324n can be configured according to the type of communication protocol and physical interface supported. For example, a first slave communication port controller 324a can be configured to support a RS-422 serial port interface. The first slave communication port controller 324a includes a peripheral controller 340b configured to interface with the communication protocol used on the backplane 350. Here, the first slave communication port controller 324a implements a USB peripheral controller 340b. The peripheral controller 340b can include, for example, USB peripheral controller integrated circuits manufactured by Intel, Philips, Cypress or some other manufacturer. The peripheral controller 340b is coupled to a port interface module 309a which provides a port interface. The port interface module in this embodiment provides an RS-422 serial port interface. The port interface module includes a processor 310b and memory 320b that are configured to support the desired RS-422 communication protocol.

A second slave communication port controller 324b can include a peripheral controller 340c, a port interface module 309b with a processor 310c, and memory 320c configured to support some other communication protocol. For example, the first slave communication port controller 324a can support an RS-422 serial interface and a second slave communication port controller 324b can support one or more parallel ports. Additional slave communication port controllers 324c-324n can be coupled to the backplane 350 until the desired configuration is achieved or the number of connections on the backplane 350 is exhausted.

The communication server 220 can be configured differently depending on the type of communication protocols and physical interfaces supported. For example, some slave communication port controllers 324a, 324b, up to and including 324n, can include processors and memory in order to convert the data between the protocols used on the internal bus and on the external communication port. Other slave communication port controllers, for example 324c, may not include processing hardware and may only include passive components. For example, if the desired communication port is a USB port, the communication protocol is already supported by the backplane 350 and no data conversion is required. Thus, the slave communication port controller may not be required to perform any data processing when the external communication protocol matches the internal bus communication protocol.

In an example of the communication server 220 of FIG. 3, the communication server 220 may receive a message sent by a host 10 over the network 40 shown in FIG. 2. The host addresses the message, for example, to a TCP/IP address, assigned to the communication server 220. An Ethernet network interface card 222 in the communication server 220 retrieves the message. The processor 310a in the master communication port controller 322 processes the message to recover the command(s), instruction(s), or data contained in the message.

The master communication port controller 322 also determines the destination for the message. The destination can be, for example a remote device or a destination internal to the communication server 220. If, for example, the message is intended for a remote device (not shown) connected to the first slave communication port controller 324a, the master communication port controller formats the message into the USB protocol used to transmit data over the internal bus of the communication server 220. The USB formatted message includes, for example, the address of the first slave communication port controller 324a to which the remote device is connected. The USB formatted message is then provided to the USB host 330 to be communicated to the destination remote device.

The USB host 330 in the master communication port controller 322 communicates the USB message to the USB hub 352 located on the backplane 350. The first slave communication port controller 324a receives the USB formatted message that is addressed to it. The peripheral controller 340b in the first slave communication port controller 324a determines that the USB formatted message is addressed to the associated slave communication port controller 324a.

The processor 310b then converts the received USB message into the communication protocol required by the remote device, for example, RS-232, RS-422, or some other protocol. The suitably formatted message is then communicated to the remote device. Data or commands initiated by a remote device follow a complementary reverse path through the communication port controllers to the host.

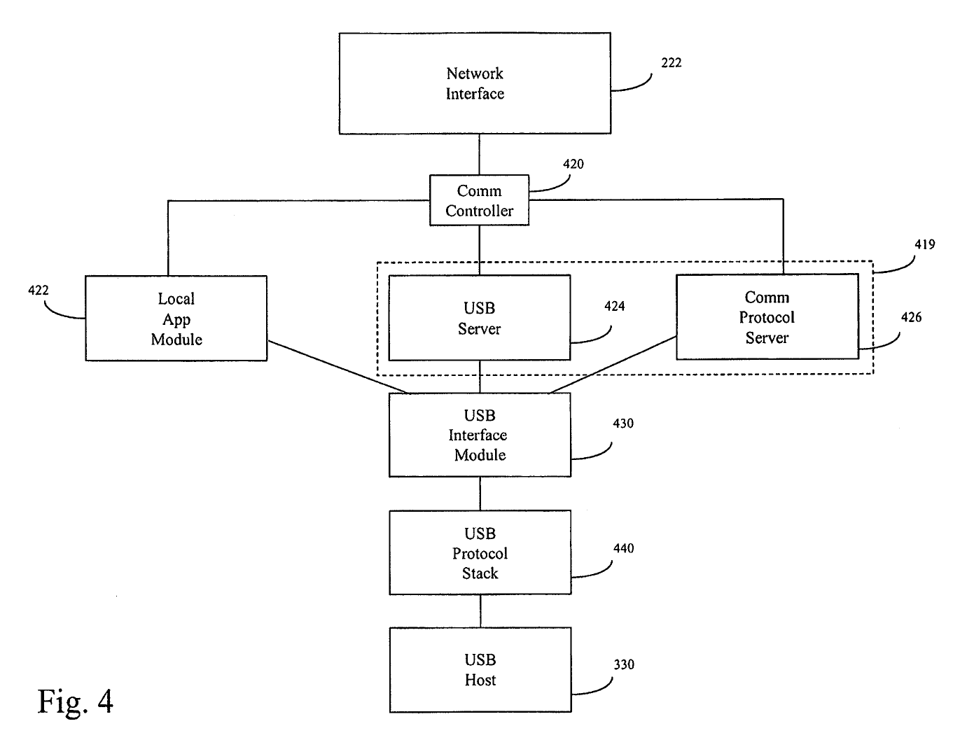

FIG. 4 is a functional block diagram of a communication port controller 322, such as the one shown in FIG. 3. The functional block diagram shows the functional operations of a master communication port controller. One or more of the functional blocks can be implemented using the processor and memory shown in the master communication port controller 322 of FIG. 3.

The master communication port controller 322 can receive data, for example, from the host via the network. The master communication port controller 322 includes a network interface module 222. The received data can be used by the master communication port controller internally, can be communicated to a remote device coupled to a port on the communication server 220 (see FIG. 2) as a local command or data, can be communicated to a remote USB device coupled to a port on the communication server 220 (see FIG. 2) as a command or data, or can be communicated to a remote device coupled to a port on the communication server 220 (see FIG. 2) as a command or data using some communication protocol.

A communication controller module 420 receives data from the network interface 222 and determines its destination within the master communication port controller 322. For example, data (which can include commands) intended for a local/remote device which is coupled to a slave communication port controller is directed to the remote device server 419. In the embodiment depicted in FIG. 4, the remote device server 419 includes a USB server 424 and a communication protocol server 426. Data intended for an external device which uses the USB protocol is directed to the USB server 424. Data intended for an external device which is coupled to a different slave communication port controller which provides an interface other than USB, is directed to the communication protocol server 426. The USB server 424 and the communication protocol server 426 convert received data to the communication protocol used by the internal bus, in this example USB. In other words, they convert that data to a format that is compatible with the internal bus. Collectively, the USB server 424 and the communication protocol server 426 are the modules that receive data and commands intended for devices which the host perceives as local/remote devices.

The local application module 422 controls the operation of and interfaces with one or more external devices which are not directly usable or accessible by a host computer. For example, one of the slave communication port controllers can be coupled to a memory storage device such as a hard disk drive. The communication server 220 can utilize that hard disk drive, for example, as a data logger, via the local application module 422. Therefore, that hard disk drive would not appear to a host as a storage device available for its use. Rather, the communication server would be using that storage device to store data relating to its operation, for example information relating to the status of other external devices coupled to the communication server.

The local application module 422, in one embodiment, also provides local management of devices on the internal USB. For example, tasks such as registration of devices, device failure and removal, are coordinated through the local application module. That coordination would include providing notification to a host in the event of a device failing or being removed, or a new device being added.

The USB interface module 430 provides an interface for converted data received from the local application module, the USB Server and the communication protocol server. The USB interface module 430, in one embodiment, includes a module running a process that provides an application programming interface for USB data. The USB interface module 430 provides the converted USB data to a USB protocol stack 440 to queue the data for delivery to the appropriate remote device. The USB protocol stack 440 provides the USB data to a USB host 330 that drives the data to the appropriate slave communication port controller for delivery to the desired remote device.

Although data delivery from the host to a remote device is described with respect to FIG. 4, data may also be delivered from a remote device to the host. The process of communicating data from a remote device to the host operates in substantially the reverse of the described process.

Data received at a communication port is converted to USB data using a USB interface module at the slave communication port controller. The USB data is communicated to the USB host 330 using the internal bus. The remaining modules then perform substantially the reverse process to communicate the data to the host.

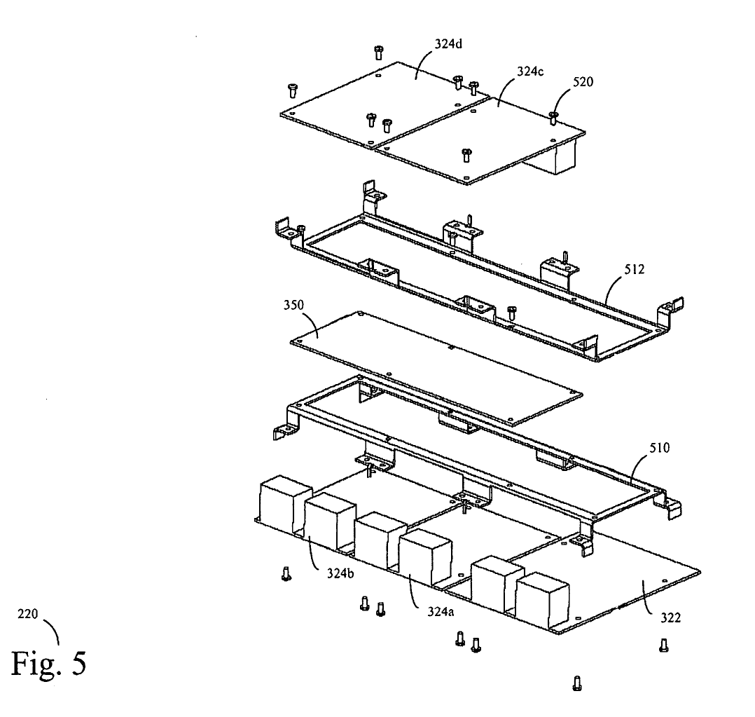

FIG. 5 is an exploded view of an embodiment of a mechanical implementation of a communication server 220, such as the communication server shown in the system of FIG. 2. A master communication port controller 322 is shown as a first module. Additional slave communication port controllers 324a-324b can be coupled to the master communication port controller 322 using via the backplane 350.

The master communication port controller 322 is mounted onto a first truss 510. The first truss 510 provides mechanical support to the assembly, but can also be used to provide one or more electrical connections between modules connected to the truss. The backplane is mounted on an opposite side of the first truss 510. Removable connections located on the master communication port controller 322 mate with complementary connections on the backplane 350. Alternatively, or in addition, a cable or some other type of interface connection may be used.

Slave communication port controllers 324a-324b removably connect with the backplane 350 and are mechanically supported by the first truss. Each slave communication port controller, for example 324a-324b, connects to a corresponding connection on the backplane 350. Each slave communication port controller 324a-324d can be configured to provide one or more communication ports corresponding to one or more communication protocols and physical interfaces. The slave communication port controllers 324a-324b can interface to the same side of the backplane 350 used to interface with the master communication port controller 322.

Additional slave communication port controllers 324c-324d can connect to the backplane 350 on a side of the backplane 350 that is opposite the side used to connect the master communication port controller 322. A second truss 512 connects to the backplane 350 on the side opposite the first truss 510. The second truss 512 provides mechanical support for additional slave communication port controllers 324c-324d and can also be used to provide one or more electrical connections.

Additional slave communication port controllers 324c-324d mount to the second truss 512 and interface to the backplane 350 through connections on the side of the backplane 350 opposite the side interfacing with the master communication port controller 322.

The communication port controllers 324a-324d typically mechanically mount to the respective trusses 510-512 using one or more fasteners 520. The fasteners 520 can be screws, rivets, bolts, standoffs, and the like, or some other type of fastener. The configuration of the communication server 220 is only limited by the configurations of the various communication port controllers 324a-324d. The number of communication ports supported by the communication server 220 is only limited by the physical and electrical capabilities of the backplane 350 and by the communication limits of the internal bus embodied on the backplane 350.

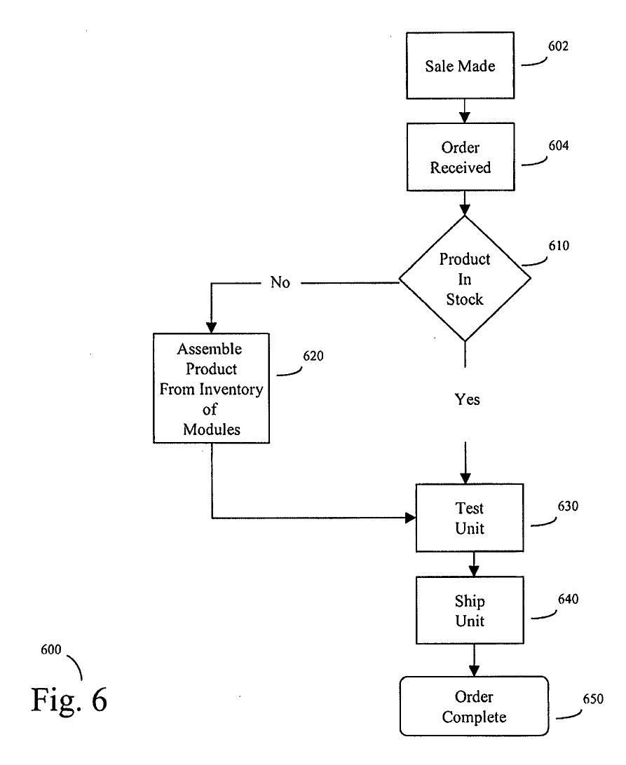

FIG. 6 is a flowchart of a process 600 of manufacturing modular communication servers. The process 600 begins at block 602 when a sale of a communication server is made. The sale can be made, for example, by receiving user input at an automated input system. In one embodiment, the automated input system includes a computer interface that allows a user to select a number and configuration of communication ports in a communication server. In another embodiment, the automated input system includes a telephone interface that allows a user to select a number and configuration of communication ports in a communication server. Other automated input systems are envisioned.

Once the sale is made, the process moves to block 604 where the order for the communication server is received. The order may be received concurrently when the sale is made. Alternatively, once the sale is made, the configuration can be queued in an automated order system.

The automated order system can proceed to decision block 610 to determine if the desired communication server is in stock. For example, an automated order system can interface with a stocking system to determine whether stock exists.

If the desired communication server does not exist, the process 600 proceeds to block 620 and the desired communication server is assembled from an inventory of modules. The communication server can be assembled automatically based on the parameters of the order. In other embodiments, some of the assembly is automated while other portions are performed manually. For example, the modules can be extracted from storage locations using automated robots and the final assembly may be performed manually. In other embodiments, the converse is true.

The modular design of the communication server allows nearly all of the modules to be stocked on a continuous basis. Various master communication port controllers can be assembled and stored. Additionally, various slave communication port controllers can be assembled and stored. Various backplane configurations can also be assembled and stored. The design of the communication server is then only limited by the number of possible combinations of master communication port controller, backplane, and slave communication port controllers.

Each module can be tested prior to placement in storage. Additionally, new modules can be added to stock as new communication port controllers supporting additional communication protocols are designed. The design of the communication server is thus extendable based on available communication port controllers.

Once the communication server is assembled, the process 600 proceeds to block 630. The completed communication server can be tested in an automated tester. The rate of failures can be minimized by stocking only tested modules. That is, the modules from which the communication server is built can all be pretested prior to being stored. The testing thus tests functions relating to the operation of the completed communication server, and tests of the individual modules can be minimized or eliminated.

Once the communication server has passed the final tests, the unit is complete and can be shipped to the customer. Thus, the modular approach to the communication server design allows a majority of a communication server to be assembled automatically even when the configuration is one that has never been previously stocked or manufactured.

Those of skill in the art will understand that information and signals can be represented using any of a variety of different technologies and techniques. For example, data, instructions, commands, information, and signals, that can be referenced throughout the above description can be represented by voltages, currents, electromagnetic waves, magnetic fields or particles, optical fields or particles, or any combination thereof.

Those of skill will further appreciate that the various illustrative logical blocks, modules, circuits, and algorithm steps described in connection with the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention.

The various illustrative logical blocks, modules, and circuits described in connection with the embodiments disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such the processor can read information from, and write information to, the storage medium. In the alternative, the storage medium can be integral to the processor. The processor and the storage medium can reside in an ASIC.

The above description of the disclosed embodiments is provided to enable any person skilled in the art to make or use the invention. Various modifications to these embodiments will be readily apparent to those skilled in the art, and the generic principles defined herein can be applied to other embodiments without departing from the spirit or scope of the invention. Thus, the invention is not intended to be limited to the embodiments shown herein but is to be accorded the widest scope consistent with the principles and novel features disclosed herein.

1. A modular communication server comprising:
a master communication port controller having a network interface module configured to communicate over a network, and a bus interface module configured to communicate over an internal bus;
an internal bus coupled to said bus interface; and
a slave communication port controller having a peripheral controller coupled to said internal bus and a port interface module in communication with said peripheral controller and configured to provide a port interface to an external device.

2. The device of claim 1 wherein said master communication port controller further comprises a communication controller module configured to receive data from the network interface module and determines its destination within the master communication port controller.

3. The device of claim 2 wherein said master communication port controller further comprises a local application module configured to control the operation one or more external devices coupled to said slave communication module and which are not directly usable or accessible by a host computer.

4. The device of claim 1 wherein said slave communication port controller comprises a plurality of port interface modules, each configured to provide a port interface to an external device.

5. The device of claim 1 further comprising a remote device server configured to receive data from a host via said network interface module and convert the data to a format suitable for an external device coupled to said port interface module.

6. The device of claim 1 wherein said master port controller further comprises a port interface for an external device.

7. A modular communication server comprising:
a plurality of port interface modules, each configured to provide a port interface;
a plurality of peripheral controllers, each coupled to one of said plurality of port interface modules and configured to provide communication via an internal bus;
an internal bus coupled to each of said plurality of peripheral controllers;
a bus interface coupled to said internal bus;
a communication controller module in communication with said bus interface module and configured to direct data to selected ones of said plurality of port interface modules via said internal bus; and
a network interface module coupled to said communication controller module and configured to provide communication over a network.

8. The device of claim 7 further comprising a local application module configured to control the operation an external device coupled to one of said port interface modules and which are not directly usable or accessible by a host computer.

9. The device of claim 7 further comprising a remote device server configured to receive data from a host via said communication controller module and convert the data to a format suitable for a selected external device coupled to one of said plurality of port interface modules.

10. A module communication server comprising:
a master communication port controller configured to receive data from and transmit data to a host over a network, and to transmit and receive data over an internal bus;
an internal bus coupled to said master communication port controller; and
a plurality of slave communication port controllers, each coupled to said internal bus and configured to provide a port interface to an external device and to transmit data to and from an external device over said internal bus.

11. The server of claim 10, wherein said master communication port controller comprises a network module configured to provide an interface to a communication network, a controller in communication with said network module and a bus interface module.

12. The server of claim 10, wherein said master communication port controller comprises:
a network interface module configured to communicate over a network,
a bus interface module configured to communicate over an internal bus,
a communication controller module in communication with said bus interface module and configured to direct data to selected ones of said port interfaces via said internal bus.

13. The server of claim 12, wherein said master communication port controller further comprises a local application module configured to control the operation of one or more external devices coupled to said one or more of said ports and which are not directly usable or accessible by a host computer.

14. A modular communication server comprising:
a master communication port controller configured to receive data from and transmit data to a host over a network, and to transmit and receive data over an internal bus, the master communication port controller comprising:
a network interface module configured to transmit and receive data over a network connection,
a communication controller module configured to receive data from the network interface module and determines the destination within the master communication port controller for the data,
a remote device server configured to receive data from the communication controller module and convert received data to the communication protocol used by an internal bus,
a local application module configured to control the operation of and interface with one or more external devices which are not directly usable or accessible by a host computer and configured to provide local management of devices on the internal bus,
an interface bus interface module 430 configured to provide an interface to the internal bus;
an internal bus coupled to said master communication port controller; and
a plurality of slave communication port controllers, each coupled to said internal bus and configured top provide a port interface to an external device and to transmit data to and from an external device over said internal bus.

15. A method of operating a modular communication server having plurality of external devices, the method comprising:
receiving data from a host computer intended for a local/remote device;
converting the data received from the host computer to a format compatible with an internal bus;
transmitting the converted data over an internal bus to a slave communication port controller; and
converting the data received at the slave communication port controller to a format compatible with the local/remote device coupled to the slave communication port controller.

16. The method of claim 15 further comprising directing to more than one local/remote device.

17. The method of claim 15 further comprising directing data to an external device on said internal bus.
